(19) United States
(12) Patent Application Publication
(10) Pub. No.: US 2012/0246288 A1
(43) Pub. Date: Sep. 27, 2012

(54) ELECTRONIC DEVICE CONTROL SYSTEM, ELECTRONIC DEVICE AND ELECTRONIC DEVICE CONTROL METHOD

(75) Inventor: Yumiko Kikuoka, Osaka (JP)

(73) Assignee: Sharp Kabushiki Kaisha, Osaka (JP)

(21) Appl. No.: 13/426,888

(22) Filed: Mar. 22, 2012

(30) Foreign Application Priority Data
Mar. 24, 2011 (JP) 2011-065378

(51) Int. Cl. G06F 15/173

(52) U.S. Cl. 709/223

(57) ABSTRACT

An electronic device includes an authentication portion for performing user authentication according to an authentication request including the user information that is sent together with image data from a client terminal; an output state determination portion for determining an output state of an image for the image data depending on the user information in a case where the user authentication is successfully performed; a preview image generation portion for generating a preview image corresponding to the output state; and a sending portion for sending to the terminal a result of the user authentication to which the preview image is added only in a case where the user authentication is successfully performed. A preview display portion displays an execution button for instructing the electronic device to execute image output together with the preview image.

### CROSS-NOTING PARAGRAPH

This non-provisional application claims priority under 35 U.S.C. §119(a) on Patent Application No. 2011-065378 filed in JAPAN on Mar. 24, 2011, the entire contents of which are hereby incorporated herein by reference.

### FIELD OF THE INVENTION

The present invention relates to an electronic device control system in which a client terminal and an electronic device are connected on a network, an electronic device thereof and an electronic device control method thereof.

### BACKGROUND OF THE INVENTION

In an electronic device control system in which a server, a client terminal and an electronic device are connected to a network to control the electronic device, a technique has been known for integrally controlling and managing a restricted function of the electronic device on the server side (see Japanese Laid-Open Patent Publication No. 2006-172094, for example).

Further, in an image forming apparatus, a technique is also disclosed for suppressing execution of image quality adjustment processing for enhancing image quality in image formation according to presence/absence of use authority of an image formation function (see Japanese Laid-Open Patent Publication No. 2010-109701, for example). With this technique, for example, it is possible to restrict execution of correction processing having less need such as position gap correction and concentration correction in a state where there is no use authority of a color print function.

However, in the system described in Japanese Laid-Open Patent Publication No. 2006-172094, an administrator sets a function to be restricted, and a user is thus not able to confirm whether or not to be able to perform desired output due to function restriction until outputting. Additionally, even with the technique described in Japanese Laid-Open Patent Publication No. 2010-109701, execution of correction processing having less need is restricted according to presence/absence of use authority of an image formation function, and a user is thus not able to confirm whether or not to be able to perform desired output due to function restriction until outputting likewise.

### SUMMARY OF THE INVENTION

An object of the present invention is to provide an electronic device control system in which a client terminal and an electronic device capable of outputting an image are connected to a network, which is capable of restricting a function on the electric device side corresponding to user information that is sent from the client terminal for user authentication, and making it possible for a user to confirm in advance an output state of an image before image output, an electronic device thereof and an electronic device control method thereof.

An object of the present invention is to provide an electronic device control system in which a client terminal and an electronic device capable of outputting an image in response to an instruction from the client terminal are connected to a network, wherein the electronic device includes an authentication portion for performing user authentication according to an authentication request including user information that is sent together with image data from the client terminal; an output state determination portion for determining an output state of an image for the image data depending on the user information in a case where the user authentication is successfully performed; a preview image generation portion for generating a preview image corresponding to the output state for the image data; and a sending portion for sending to the client terminal a result of the user authentication to which the preview image is added only in a case where the user authentication is successfully performed, and the client terminal includes a preview display portion for displaying an execution button for instructing the electronic device to execute image output together with the received preview image.

Another object of the present invention is to provide the electronic device control system, wherein the client terminal sends function setting information that is used in the electronic device to the electronic device together with the image data.

Another object of the present invention is to provide the electronic device control system, wherein the electronic device includes a restriction information storage portion for correlating and storing user information, restriction function information indicating a function whose usage is restricted among functions of the electronic device, and an alternative function information indicating a function that is used as an alternative of the restricted function.

Another object of the present invention is to provide the electronic device control system, wherein the output state determination portion determines an output state of the image for the image data depending on the user information and the function setting information that are received from the client terminal with reference to the restriction information storage portion.

Another object of the present invention is to provide an electronic device that is connected to a client terminal via a network and capable of outputting an image in response to an instruction from the client terminal, comprising: an authentication portion for performing user authentication according to an authentication request including user information that is sent together with image data from the client terminal; an output state determination portion for determining an output state of an image for the image data depending on the user information in a case where the user authentication is successfully performed; a preview image generation portion for generating a preview image corresponding to the output state for the image data; and a sending portion for sending to the client terminal a result of the user authentication to which the preview image is added only in a case where the user authentication is successfully performed, wherein image output for the image data is executed when an instruction to execute image output is received from the client terminal after the preview image is sent.

Another object of the present invention is to provide an electronic device control method in an electronic device control system in which a client terminal and an electronic device capable of outputting an image in response to an instruction from the client terminal are connected to a network, comprising the steps of: sending an authentication request including user information together with image data to the electronic device by the client terminal; performing user authentication according to the authentication request by the electronic device; determining by the electronic device an output state of an image for the image data depending on the user information in a case where the user authentication is successfully performed; generating a preview image corresponding to the output state for the image data by the electronic device; sending to the client terminal by the electronic device a result of the user authentication to which the preview image is added only in a case where the user authentication is success fully performed; and displaying by the client terminal an execution button for instructing the electronic device to execute image output together with the received preview image.

### BRIEF DESCRIPTION OF THE DRAWINGS

FIG. 1 is a block diagram showing a schematic configuration of an electronic device control system according to an embodiment of the present invention;

FIG. 2 is a diagram showing an example of a user table that is stored in an electronic device in the electronic device control system of FIG. 1;

FIG. 3 is a diagram showing an example of a group user table that is stored in the electronic device in the electronic device control system of FIG. 1;

FIG. 4 is a diagram showing an example of a function table that is stored in the electronic device in the electronic device control system of FIG. 1;

FIG. 5 is a diagram showing an example of a restriction/alternative table that is stored in the electronic device in the electronic device control system of FIG. 1;

FIG. 6 is a diagram showing an example of a group management table that is stored in the electronic device in the electronic device control system of FIG. 1;

FIG. 7 is a diagram showing an example of a function restriction management table that is stored in the electronic device in the electronic device control system of FIG. 1;

FIG. 8 is a flowchart for explaining operation on a client terminal in the electronic device control system of FIG. 1;

FIG. 9A is a diagram showing an example of a display screen on the client terminal for explaining the operation of FIG. 8;

FIG. 9B is a diagram showing an example of the display screen transited from the display screen of FIG. 9A; and

FIG. 10 is a flowchart for explaining operation on the electronic device in the electronic device control system of FIG. 1.

### PREFERRED EMBODIMENTS OF THE INVENTION

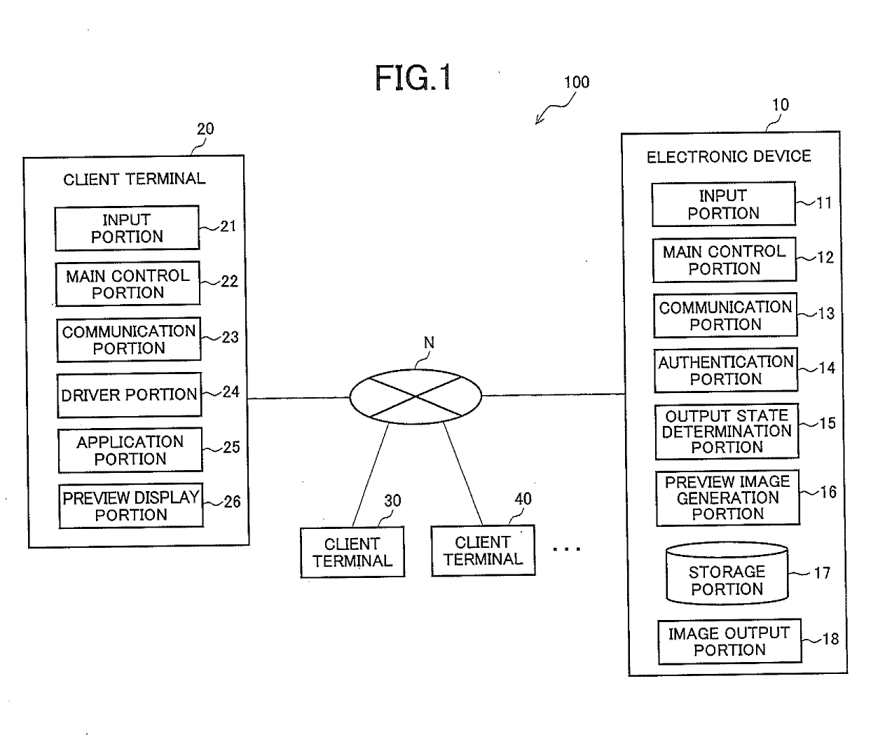

FIG. 1 is a block diagram showing a schematic configuration of an electronic device control system according to an embodiment of the present invention. In an electronic device control system 100 according to the present embodiment illustrated in FIG. 1, an electronic device 10 is connected to a client terminal 20 via a network N so as to be able to communicate mutual data.

Note that, description will be given for a system configuration in which only one unit for each of the client terminal 20 and the electronic device 10 is connected, however, the system configuration is not limited thereto, and as illustrated in an example in which client terminals 30 and 40 are connected to the network N, a system in which a plurality of the client terminals 20 are connected to the network N is also applicable likewise. Of course, it is similarly applicable also to a system in which a plurality of the electronic devices 10 are connected to the network N, and the same is true also in a system in which a plurality of both the client terminals 20 and the electronic devices 10 are included. In the case of including a plurality of electronic devices 10, electronic devices which are different in type from one another may be included at least as long as it is possible to perform image output.

First, the electronic device 10 will be described. The electronic device 10 includes, for example, a single-function image forming apparatus such as a printer and a facsimile device, a multi-functional peripheral including a plurality of functions such as a print function and a facsimile function, and the like. Note that, the electronic device 10 is preferably a device capable of performing image output even by user operation from an operation portion that is provided in the body.

The electronic device 10 is provided with an input portion 11, a main control portion 12, a communication portion 13, an authentication portion 14, an output state determination portion 15, a preview image generation portion 16, a storage portion 17 and an image output portion 18. With these components, the electronic device 10 is configured to be able to perform image output at the image output portion 18 in response to an instruction via the network N from the client terminal 20 concerning image data that is created at the client terminal 20.

The image output portion 18 outputs an image of the image data received in this manner. For example, in a case where the electronic device 10 is a printer, the image output portion 18 outputs a sheet printed. Note that, the image output portion 18 may be provided with an ASIC (Application Specific Integrated Circuit) for the purpose of control thereof. Further, another configuration is also allowed including the ASIC as the main control portion 12.

The input portion 11 accepts input of a user account by a user who uses the electronic device 10, and input for associating a restriction function as well as an alternative function registered in the electronic device 10, user account setting and group setting with one another. Such input may be accepted from an external device such as a personal computer (PC). Here, the restriction function refers to a function that is restricted among functions of the electronic device 10, and the alternative function refers to a function serving as an alternative of the restriction function.

The main control portion 12 is provided with a CPU (Central Processing Unit), a RAM (Random Access Memory) as a work area, a ROM (Read Only Memory) as a storage area of a program for control and the like, and controls various functions in the electronic device 10. The communication portion 13 performs communication with the client terminal 20 through the network N so as to receive from the client terminal 20 image data to be output, a user account and an image output instruction as well as sending a response to the reception. In sending the response in this manner, as described below, sending of an authentication result based on the user account and a preview image that is generated at the preview image generation portion 16 is performed.

The storage portion 17 stores data in which the restriction function as well as the alternative function, the user account setting and the group setting are associated with one another. Specifically, the main control portion 12 sets/registers in the storage portion 17 data in which the restriction function as well as the alternative function, the user account setting and the group setting are associated with one another, which are input through the input portion 11. As illustrated in the main control portion 12 and the storage portion 17, the electronic device 10 is preferably provided with a restriction information storage portion for storing user information (that is, information of a user account, or information of a user account and information of group setting), restriction function information indicating a function which use is restricted among functions of the electronic device 10 and alternative function information indicating a function that is used as an alternative of the restricted function which are associated with one another. Note that, in the case of not storing the restriction function information and the alternative function information, for example, the user information may only be stored by being associated with function restriction information for simply stopping the function.

The authentication portion 14 performs user authentication with reference to the storage portion 17 according to an authentication request including the user information that is sent with image data from the client terminal 20. The authentication portion 14 informs the main control portion 12 on a user authentication result. The main control portion 12 returns the user authentication result to the client terminal 20 which sent the user information via the communication portion 13.

In the present invention, however, sending of a preview image is also performed at the time of successfully performing the user authentication. Therefore, the electronic device 10 is provided with the output state determination portion 15. The output state determination portion 15 determines an output state of an image for the above-described image data corresponding to the above-described user information in a case where the user authentication is successfully performed.

Such determination is preferably executed according to the restriction function and the alternative function corresponding to the user information in the storage portion 17. Of course, whether to correspond to the restriction function depends on setting details of the image data sent form the client terminal 20. Accordingly, the client terminal 20 sends function setting information that is used in the electronic device 10 to the electronic device 10 together with image data to be output. Here, the function setting information may be included in image data to be sent, or simply be a function selection signal indicating a function that is selected by a user from among a plurality of existing functions.

In this manner, the output state determination portion 15 determines the output state of the image for the received image data corresponding to the user information and the function setting information received from the client terminal with reference to the above-described restriction information storage portion. Here, the function setting information refers to information indicating setting details in image output.

Description will be given for a specific processing example of the authentication portion 14 and the output state determination portion 15. The authentication portion 14 searches whether or not information of the user account received from the client terminal 20 is included in the data in which the restriction function as well as the alternative function, the user account setting and the group setting are associated with one another which is stored in the storage portion 17. Such search corresponds to user authentication. Therefore, in the case of necessity for management, user ID and a password may be employed as user account information.

As the result of the search, the output state determination portion 15 is activated in a case where the user account information is stored (in a case where user authentication is successfully performed), that is, in a case where the user account information for the image data received from the client terminal 20 is included in the above-described data in which association is performed. In a case where user authentication is successfully performed, the output state determination portion 15 reads the restriction function information as well as the alternative function information that are associated with the user account information.

Note that, an explanation is provided assuming that only the user account information is sent from the client terminal 20, while the group setting is only stored in the storage portion 17, however, it may be configured that the user account information and group setting information are sent from the client terminal 20 so that the output state determination portion 15 executes search from the sent information.

Then, the output state determination portion 15 makes a change of rewriting, among setting details indicated by function setting information from the function setting information sent together with the user account information and the read restriction function information as well as alternative function information, setting indicated by the restriction function to setting indicated by the alternative function.

The preview image generation portion 16 generates a preview image of image data based on the setting details after the change, that is, a preview image corresponding to an output state for received image data. Subsequently, the main control portion 12 sends to the client terminal 20 via the communication portion 13 a result of user authentication to which the preview image is added only in a case where the user authentication is successfully performed. That is, the electronic device 10 is provided with a sending portion for performing sending as explained, as processing of the main control portion 12 and the communication portion 13 here.

In this manner, at the output state determination portion 15 and the preview image generation portion 16, based on the read restriction function information and alternative function information, a part corresponding to the restriction function information of the function setting information in the received image data is changed into the alternative function information, and a preview image concerning the image data after the change is generated. As a simple example, in the case of setting in the storage portion 17 for a user A who is prohibited to perform color printing, and instead, executes monochrome printing, as the output state of an image, the received image data is determined to be in a state of the monochrome printing so as to generate the preview image in the state of the monochrome printing.

The main control portion 12 then performs sending of an authentication result based on the user account information and the preview image that is generated at the preview image generation portion 16. Further, the main control portion 12 instructs, in the case of receiving an instruction of execution of image output from the client terminal 20 at the communication portion 13 after sending the preview image, the image output portion 18 to execute the image output for the image data.

Note that, in the storage portion 17, image data that is received from the client terminal 20 and has a function that is not restricted, and image data that is rewritten by the alternative function may be temporarily stored at least until an image output instruction or a cancel instruction of the corresponding image data is provided. That is, in the storage portion 17, when image data is received from the client terminal 20 and user authentication is successfully performed, the image data capable of being output in the electronic device 10 (coming not to include a restriction function) is stored. Thereby, a user who views a preview image is able to read the image data in the storage portion 17 to execute image output without sending the image data again even when operating the client terminal 20 results in an image output instruction.

Next, description will be given for the client terminal 20. The client terminal 20 is composed of a PC, a personal digital assistance (PDA) or the like, and provided with an input portion 21, a main control portion 22, a communication portion 23, a driver portion 24, an application portion 25 and a preview display portion 26, in which image data to be output at the electronic device 10 is created, output and displayed as a preview. Note that, an explanation is provided assuming that image data to be output is created at the client terminal 20, however, data simply captured from an external recording medium, another client terminal or the like is also able to be intended to be output.

The input portion 21 accepts input for creation of data at the application portion 25, operation at the driver portion 24 and operating the preview display portion 26 and the like. The main control portion 22 is provided with a CPU, a RAM as a work area, a ROM as a storage area of a program in an operation system and the like, and performs control in the client terminal 20. The communication portion 23 sends image data and user account information to the electronic device 10 through the network N.

The application portion 25 includes application software, and creates image data to be output in the electronic device 10. The driver portion 24 converts data created at the application portion 25 into image data in a data form capable of being output in the electronic device 10. Additionally, the driver portion 24 calls the preview display portion 26 in a case where a preview image is sent from the electronic device 10.

The preview display portion 26 includes a preview display control portion for performing control for a display portion and for performing preview display at the display portion. The preview display portion 26 in the present invention displays an execution button for instructing the electronic device 10 to execute image output together with a preview image received from the electronic device 10. Here, a result of successful authentication may also be displayed as a character or the like. Note that, when authentication fails, the main control portion 22 causes the display portion to display a result of failed authentication as a character or the like.

With such a configuration, in the client terminal 20, for the image data that is crated at the application portion 25, the driver portion 24 activates the preview display portion 26 automatically or by a preview instruction or a print instruction of a user from the input portion 21, as well as sending image data to be output together with a user account for user authentication. Then, the preview display portion 26 displays a received preview image and an image output execution button in a case where the user authentication is successfully performed. The driver portion 24 then instructs the electronic device 10 to execute image output in a case where the image output execution button is selected. Thereby, the image output is executed at the electronic device 10.

As described above, in the electronic device control system 100 according to the present invention, it is possible not only to restrict a function on the electronic device 10 side corresponding to user information that is sent from the client terminal 20 for user authentication, but also for a user to confirm in advance an output state of an image before image output.

Next, specific description will be given for processing of the electronic device control system 100 according to the present embodiment providing an example of a case where the electronic device 10 is a printer. Note that, in the following example, an example in which group management is employed is mainly shown, however, it is possible to structure the electronic device control system 100 as a system for processing only an account of an individual user without performing the group management.

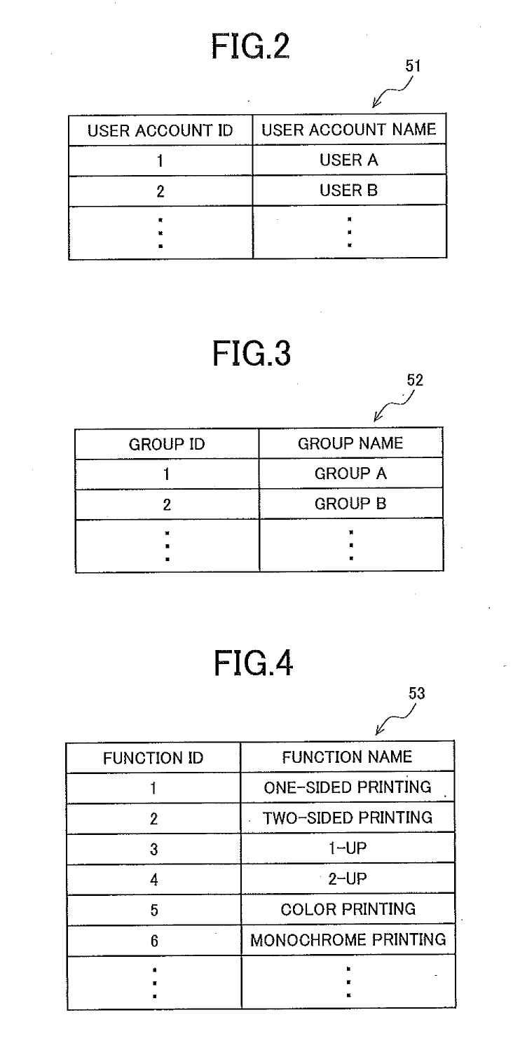

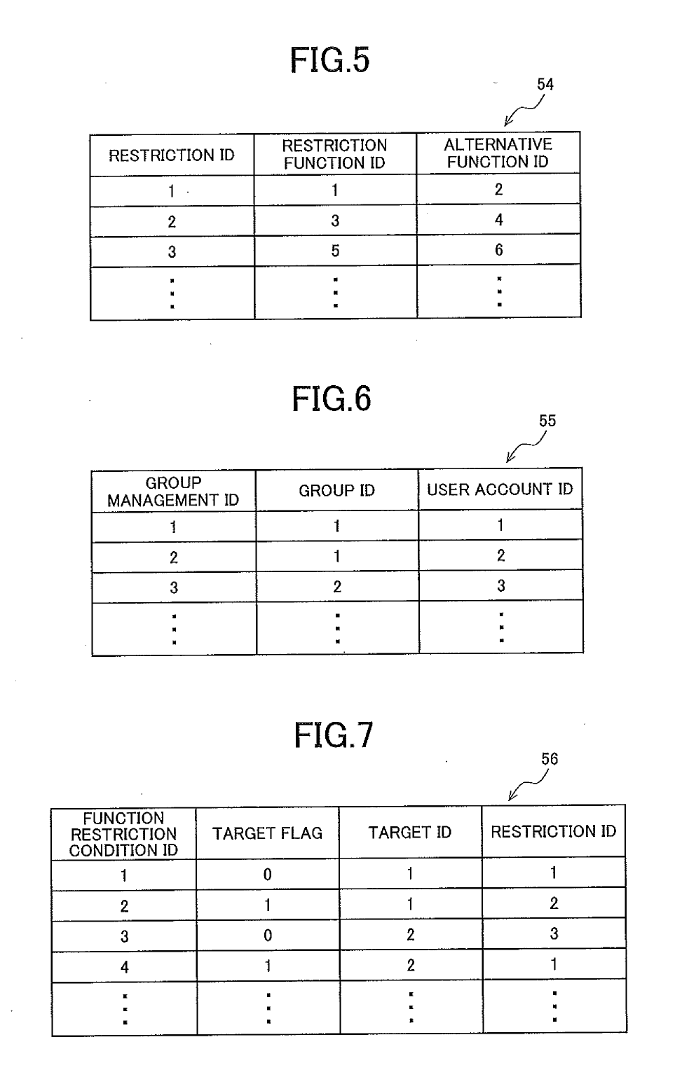

First, description will be given for an example of restriction of a function. FIG. 2 to FIG. 7 are diagrams showing an example of data in which the restriction function as well as the alternative function, the user account setting and the group setting are associated with one another, which is stored in an electronic device in the electronic device control system according to the present embodiment. Here, FIG. 2, FIG. 3, FIG. 4, FIG. 5, FIG. 6 and FIG. 7 are diagrams showing an example of a user table, an example of a group user table, an example of a function table, an example of a restriction/alternative table, an example of a group management table and an example of a function restriction management table that are stored in the storage portion 17, respectively, in which these tables are stored by being associated with one another in the storage portion 17 as the following example. Note that, a method of association, a format of a table and the like are not limited to illustration here.

A user table 51 is a table in which a user account is registered, and ID of a user account and a user account name are stored. For example, on a first line (first record) of the user table 51, “1” as the user account ID and a “user A” as the user account name are indicated. A group table 52 is a table in which a group is registered, and group ID and a group name are stored. For example, on a first line of the group table 52, “1” as the group ID and a “group A” as the group name are indicated.

A function table 53 is a table in which various functions are registered, and function ID and a function name are stored. For example, on a first line of the function table 53, “1” as the function ID and “one-sided printing” as the function name are indicated. The function name also includes two-sided printing, 1-UP (printing one page on one sheet), 2-UP (printing two pages on one sheet), color printing, monochrome printing and the like.

A restriction/alternative function table 54 is a table in which the restriction function and the alternative function are registered, and restriction ID, restriction function ID, and alternative function ID are stored. For example, on a first line, “1” as the restriction ID and “1” as the restriction function ID are indicated, which thus indicates the “one-sided printing” from the function table 53, while “2” as the alternative function ID is indicated, which thus indicates the “two-sided printing” from the function table 53.

A group management table 55 is a table in which a user account is associated with a group, and group management ID, group ID and a user account ID name are stored. For example, on a first line, “1” as the group management ID and “1” as the group ID are indicated, which thus indicates the “group A” from the group table 52, while “1” as the user account ID is indicated, which thus indicates the “user A” from the user table 51.

A function restriction management table 56 is a table in which the restriction function, the alternative function, a user account or a group are associated with one another, and function restriction condition ID, a target flag, target ID and restriction ID are stored. The target flag represents whether a target to be restricted is a group or a user account, in which “0” is intended for the user account and “1” is intended for the group. The target ID corresponds to the target flag, in which “0” as a target for the user account represents the user account ID, and “1” as a target for the group represents the group ID. For example, on a first line, “1” as the function restriction condition ID, “0” as the target flag, that is, the “target for the user account”, and “1” as the target ID are indicated, which thus indicates the “user A” from the user table 51. Further, on the first line, “1” as the restriction ID is indicated, which thus indicates “1” as the restriction function ID as well as “2” as the alternative function ID from the restriction/alternative function table 54, that is, the “one-sided printing” as the restriction function and the “two-sided printing” as the alternative function from the function table 53.

For example, search of the user A while the group management is also performed is as follows.

When “1” as the user account ID is input, it is found that the “user A” is indicated from the user table 51, and “1” as the group ID is indicated from the group management table 55, that is, belonging to the “group A” is indicated from the group table 52. Therefore, “0” as the target flag as well as “1” as the target ID, that is, a condition of the “user A” (user A's own condition), and “1” as the target flag as well as the “1” as the target ID, that is, a condition of the “group A” (condition of the group to which the user A belongs) in the function restriction management table 56 are extracted.

“1” and “2” correspond to the function restriction condition ID from the function restriction management table 56, in which “1” and “2” as the restriction ID are indicated, respectively. The restriction/alternative function table 54 shows a combination of “1” as the restriction function ID and “2” as the alternative function ID, and a combination of the “3” as the restriction function ID and “4” as the alternative function ID. It is found from the function table 53 that the “two-sided printing” as the alternative function of the “one-sided printing” as the restriction function, and “2-UP” as the alternative function of “1-UP” as the restriction function are indicated.

In other words, when the user A performs output, it is found that a change is made into the “two-sided printing” in a case where the “one-sided printing” is set, and into “2-UP” in a case where “1-UP” is set.

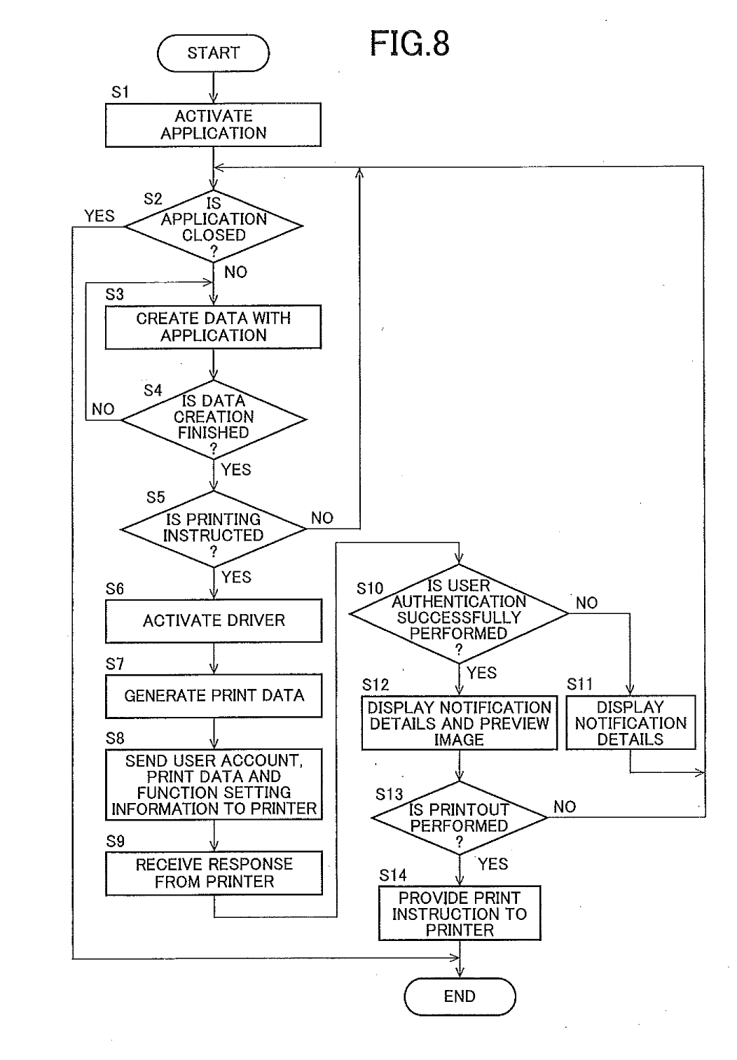

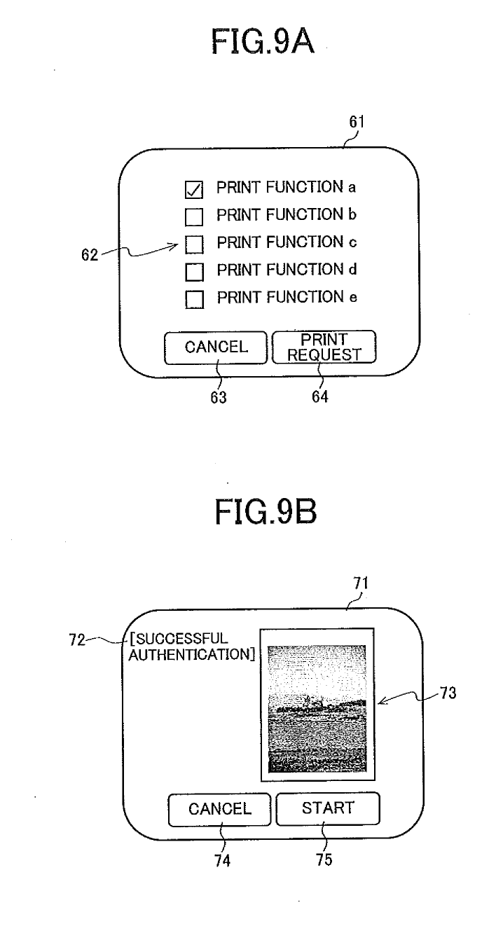

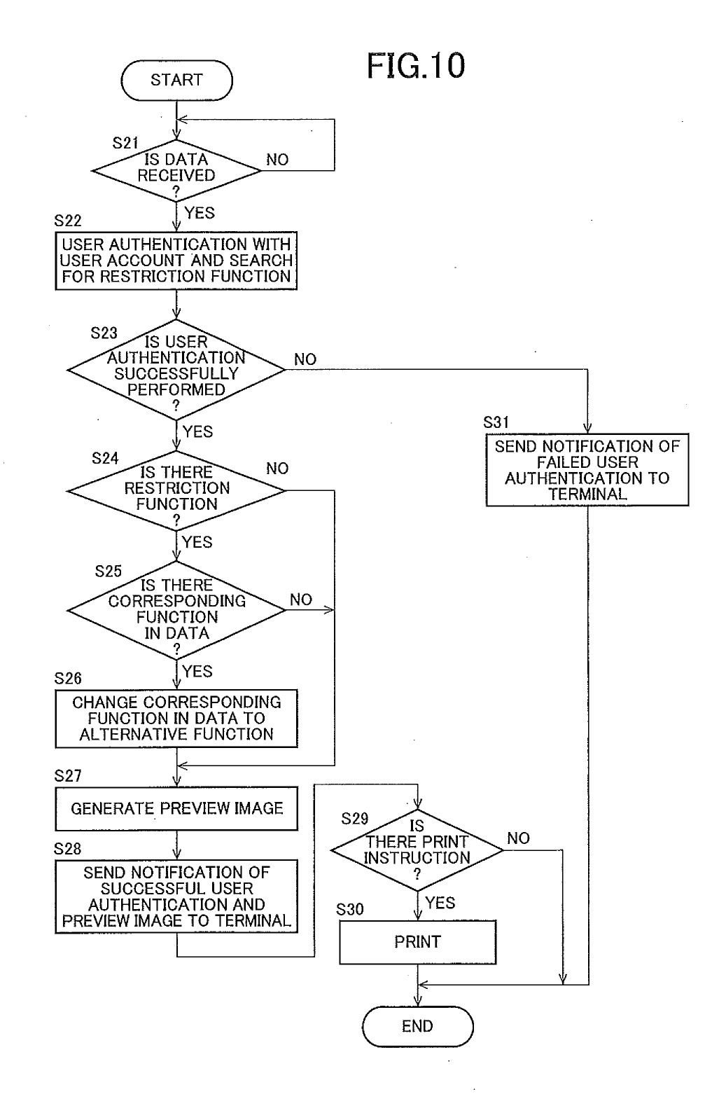

Next, description will be given for a processing example at each device in the electronic device control system 100 according to the present embodiment with reference to FIG. 8 to FIG. 10. Each of FIG. 8 and FIG. 10 is a flowchart for explaining operation on a client terminal and operation on an electronic device in the electronic device control system of FIG. 1. Further, FIG. 9A and FIG. 9B are diagrams showing an example of screen transition on the client terminal for explaining the operation of FIG. 8. An explanation will be provided also below giving an example of a printer as the electronic device 10.

First, an operation example on the client terminal 20 will be explained based on FIG. 8, FIG. 9A and FIG. 9B.

A user performs activation operation from the input portion 21 so that the main control portion 22 activates the application portion 25 on the client terminal 20 (step S1). The main control portion 22 judges whether or not an instruction to close an application is provided from the input portion 21 (step S2), and in a case where the instruction is provided, the process is finished. On the other hand, in a stage having no instruction to close (in the case of NO at step S2), the main control portion 22 continues an activation state of the application, and the application portion 25 performs data creation according to an instruction from the input portion 21 (step S3).

Next, the main control portion 22 judges whether or not an instruction to finish the data creation is provided from the input portion 21 (step S4), and causes the application portion 25 to continue to perform the data creation at step S3 until the instruction to finish the data creation is provided (until becoming YES). In the case of YES at step S4, the main control portion 22 judges whether or not a print instruction is provided from the input portion 21 (step S5). In the case of NO at step S5, the process returns to step S2. Here, the instruction to finish the data creation concerning step S4 is cleared in a case where an instruction is provided indicating that it comes time to output, in which an output instruction (print instruction concerning step S5 in this example) is applicable, and step S4 thus may not be needed.

On the other hand, in the case of YES at step S5, the main control portion 22 activates the driver portion 24 (step S6), and the driver portion 24 creates image data for printing (that is, print data) (step S7). Such print data is assumed to include setting details for which a user desires by user operation, and the setting details are assumed to be set by the user after activation of the driver portion 24 in the stage of the print instruction at step S5 or as the following explanation.

In order to allow the print setting to be changeable by a user, for example, the driver portion 24 is configured, when the driver portion 24 is activated by the print instruction (instruction to call the driver portion 24) at step S5 (step S6), to display a user interface (UI) image such as an image 61 illustrated in FIG. 9A on the display portion in the client terminal 20.

In this UI, in an selection area 62 of the image 61, operation is performed for selecting one or a plurality of print functions a to e settable on the driver portion 24 so that it is possible to set to setting details for which a user desires using the selected print function. The print function includes, for example, one-sided printing, two-sided printing, 2-UP printing (function that prints two sheets in sizes that are reduced for aggregation on one sheet), 4-UP printing (function that prints four sheets in sizes that are reduced for aggregation on one sheet), and the like. Of course, the UI like performing more complicated setting may be displayed in place of the image 61, or a hierarchical UI image may be displayed.

Additionally, on the image 61, a print request button 64 for sending a print request to a printer 10, and a cancel button 63 for canceling printing other than the selection area 62 are displayed so as to be selectable. When the cancel button 63 is selected, the driver portion 24 stops printing (not illustrated, but the process returns to step S2 like the case of NO at step S5). On the other hand, when the print request button 64 is selected, the driver portion 24 performs generation of print data at step S7.

Following step S7, the driver portion 24 sends user information such as user account information, print data and function setting information indicating setting details to the printer 10 from the communication portion 23 via the network N (step S8). Here, along with the user information, a request of user authentication is also assumed to be sent. The user information to be sent is obtained, in an environment where such information has already been input from the input portion 21 at the time of login to the client terminal 20 and the like, or the client terminal 20 is used only by a specific user, by reading the user information of a user that is allocated in advance to the client terminal 20.

Next, the driver portion 24 receives a response to sending at step S8 from a printer (step S9). An example of such response processing in the printer 10 will be described below with reference to FIG. 10.

The driver portion 24 judges from the received response whether or not user authentication is successfully performed (step S10). In the case of failed, notification details included in the response (that is, notification that the user authentication fails) are displayed on the display portion (step S11), and the process returns to step S2.

On the other and, in the case of being successfully performed, the driver portion 24 activates the preview display portion 26 to display on the display portion the preview image and the print execution button together with notification details included in the response (that is, notification that the user authentication is successfully performed) (step S12). For example, as a UI image 71 illustrated in FIG. 9B, notification of “successful authentication” 72, a preview image 73 and a start button (print execution button) 75 are displayed. Additionally, as illustrated in the UI image 71, a cancel button 74 may also be displayed. The preview image 73 displayed here is a preview image corresponding to the print function selected in the UI image 61, that is, a preview image in the case of printing with setting details for which a user desires. Then, the main control portion 22 judges whether or not the start button 75 or the cancel button 74 is operated by the user from the input portion 21, and informs the judgment result to the driver portion 24.

When the start button 75 is operated (in the case of YES at step S13), the main control portion 22 informs the driver portion 24 that print execution is instructed, and the driver portion 24 gives a print instruction to the printer via the communication portion 13 (step S14), then the process is finished. Along with the print instruction, the preview display portion 26 erases the display. Note that, at the time of such a print instruction, print data may be sent again. On the other hand, when the cancel button 74 is operated (in the case of NO at step S13), the main control portion 22 informs the driver portion 24 that print cancel is instructed, and the preview display portion 26 erases the display, then the process returns to step S2. Note that, at the time of the print cancel, the driver portion 24 may give a cancel instruction to the printer via the communication portion 13. This makes it possible to log off at the printer.

Next, description will be given based on FIG. 10 for an operation example at the printer 10 in such an example, that is, an operation example in a case where image data and function setting information are received together with a user authentication request on the printer 10 from the client terminal 20.

The main control portion 12 of the printer 10 judges whether or not these output data are received at the printer 10 in the communication portion 13 from the client terminal 20 (step S21). In the case of not being received (in the case of NO), the process is finished, and in the case of being received (in the case of YES), the authentication portion 14 and the output state determination portion 15 perform search whether a corresponding user account is present, and in the case of being present, search a restriction function of the corresponding user account (step S22). In a case where user authentication fails (in the case of NO at step S23), the authentication portion 14 sends such notification to the client terminal 20 (step S31), then the process is finished.

In a case where the user authentication is successfully performed (in the case of YES at step S23), the output state determination portion 15 judges whether or not the restriction function of the corresponding user account is present (step S24).

In a case where there is function restriction of the corresponding user account (in the case of YES at step S24), the output state determination portion 15 analyzes/judges whether or not the restriction function is included in the received function setting information of image data (step S25). In a case where there is a corresponding function (in the case of YES at step S25), the output state determination portion 15 changes the corresponding restriction function in received output data into an alternative function (step S26), and the preview image generation portion 16 generates a preview image thereof (step S27). On the other hand, in a case where there is no corresponding function (in the case of NO at step S25), the process goes to step S27 accordingly without performing operation at step S26, and the preview image generation portion 16 generates the preview image thereof.

The preview image that is generated in this manner is sent with notification of successful user authentication to the client terminal 20 via the communication portion 13 by control of the main control portion 12 (step S28). This makes it possible to display the UI image 71 as shown in FIG. 9B. Then, the main control portion 12 judges whether or not a print execution instruction is received at the communication portion 13 from the client terminal 20 after sending the preview image (step S29), and in the case of YES, instructs the image output portion 18 to execute printing for the image data (step S30). Note that, at the time of such a print instruction, in a form in which print data is sent again, the print data that is received later may be used. Further, unnecessary data after printing is deleted from the storage portion 17. In the case of NO at step S29, that is, in the case of receiving a print cancel instruction, the process is finished accordingly, however, unnecessary data that is stored in the storage portion 17 is deleted also here.

As described above, in the electronic device control system according to the present invention, user information (account information) of user account setting, group setting and the like, function restriction information and alternative function information are associated with one another to be stored in an electronic device, and changes into a restriction function and an alternative function thereof are allowed corresponding to user information of a user who uses a client terminal or the electronic device, so that it is possible to integrally manage restriction of functions for each of the user information. In other words, policy setting to the electronic device is performed for function restriction and an alternative function for a user account or the user account and group setting, and the policy setting makes it possible to perform control of function restriction such as prohibition of two-sided printing, for example.

Additionally, in the electronic device control system according to the present invention, a user is allowed to confirm before output in advance details of image data that is output by the user in the case of operating a client terminal to perform image output by the electronic device. That is, it is possible to confirm by means of a preview function at the client terminal whether or not a result of the function restriction is desired output before finishing output work at the electronic device. Therefore, it is possible to prevent in advance from performing undesired output by function restriction, and prevent unnecessary output by erroneous operation of the user.

Moreover, the electronic device includes a common printer such as an electrophotographic printer as an example which does not refers to an installation location of the printer, in which the electrophotographic printer may however be installed, for example, in an outside facility such as a store where photographic print, binding and the like are performed. More specifically, in FIG. 1, Internet as the network N, and a kiosk terminal at a convenience store or an electrophotographic printer at a DPE (Development, Printing, Enlargement) shop as the electronic device 10 are exemplified. In such a usage environment, a user is able to use the client terminal 20 such as a personal digital assistance or a PC at home to request online photographic print from a homepage of a store thereof. Especially, the user is able to obtain a photograph in image quality and a size corresponding to a user account, that is, a photograph in image quality and a size conforming to restriction function information and alternative function information that are set in advance on the electronic device 10 according to a user account from an installation location of the electrophotographic printer or by delivery therefrom. Then, the user is able to view the photograph in the image quality and the size at the client terminal 20 in advance, thus allowed to determine whether or not to actually request after viewed.

Further, an example is provided for information that is stored by being associated with restriction function information and alternative function information in the electronic device 10 is user account information, or the user account information and group setting information, however, may be user type information indicating types of users, instead. In other words, in the electronic device 10, user information that is defined by any of the user account information, the user account information as well as the group setting information, and the user type information may be stored in association with the restriction function information and the alternative function information.

The user type information is information for specifying a user by a user type in the electronic device 10. In the electronic device 10, a table in which the user type information is associated with an available function (restriction function information and alternative function information) is stored. Then, the client terminal 20 sends the user type information to the electronic device 10 based on input by user operation, insertion of an IC card and the like, thereby making it possible to perform preview display from the electronic device 10 according to an available output function (print function and the like) corresponding to the user type. Thereby, only the available function may be managed corresponding to the user type on the electronic device 10, and there is no need to manage all users individually, thus simplifying a load on the electronic device 10 and work of an administrator of the electronic device 10.

For example, the user type information includes a numerical value indicating a rank of a user that is described in a membership card of online photographic print, and the like. The membership card does not need to be the IC card, which rank is able to be read by a scanner as long as information concerning the rank is printed on the surface thereof. The electronic device 10 may refer to a table in which the rank of the user is described by an encrypted numerical value, thereby decrypting on the electronic device 10 to judge the rank, and perform function restriction to use the alternative function thereof. Further, the rank of the user includes a user on which a high fee is imposed, a user on which a regular fee is imposed, a user in a free trial and the like. As an example of a method of restricting, it is possible to use for color print restriction, image quality print restriction and the like of advertisement data according to the rank (for example, past record of purchase) of the user.

As described above, description has been mainly given for the electronic device control system according to the present invention and each device in the system, however, as a flow of control in each device is illustrated, a form is able to be employed as an electronic device control method in the electronic device control system in such a connection form. The electronic device control method according to the present invention includes the steps of sending, performing authentication, determining, generating, sending an authentication result and displaying a preview as below.

A simple explanation is provided for each step. The step of sending is a step of sending an authentication request including user information together with image data to the electronic device by the client terminal. The step of performing authentication is a step of performing user authentication according to the authentication request by the electronic device. The step of determining is a step of determining by the electronic device an output state of an image for the above-described image data corresponding to the user information in a case where the user authentication is successfully performed. The step of generating is a step of generating a preview image corresponding to the output state for the above-described image data by the electronic device.

The step of sending is a step of sending to the client terminal by the electronic device a result of the user authentication to which the preview image is added only in a case where the user authentication is successfully performed. In a case where the user authentication fails, only the failed result is sent. The step of displaying a preview is a step of displaying by the client terminal an execution button for instructing the electronic device to execute image output together with the received preview image. Note that, as an applicable example of the electronic device control method according to the present invention, various examples described above are applicable as an explanation of the electronic device control system likewise, which explanation is thus omitted.

Further, as described as the programs in the electronic device 10 and the client terminal 20, for the present invention, as each portion in each device in the system in which the above-described embodiment is configured, a form as a program for causing a computer to function and a recording medium that records the program may also be employed. Such a program is also referred to a program for causing a computer (main control portion) of each device to execute the above-described electronic device control method.

The program that is recorded in the recording medium and the program that is received through a network are stored in a memory or a storage device that is provided in an appropriate device, so that the computer (main control portion) executes the program, thereby making it possible to realize a function of the present invention. For example, as a driver program for performing control at each of portions 24 and 26 of FIG. 1 and a program for performing control at each of portions 14 to 16 of FIG. 1, each of which is incorporated as a program into the client terminal and the electronic device, so that it is possible to perform preview display at the time of successful authentication by which these programs are operated in a cooperated manner.

Note that, the above-described recording medium may be a recording medium in any form of a disk system (for example, a magnetic disk, an optical disk and the like), a card system (for example, a memory card, an optical card and the like), a semiconductor memory system (for example, a ROM, a nonvolatile memory and the like), a tape system (for example, a magnetic tape, a cassette tape and the like), or the like. Further, receiving through a network refers to receiving a program that is recorded in a storage device of an external server, or the like.

In this manner, the function of the present invention is programmed to be distributed, thereby making it possible to enhance reduction in cost, portability and versatility.

As described above, according to the present invention, in the electronic device control system in which a client terminal and an electronic device capable of outputting an image are connected to a network, it becomes possible to restrict a function on the electronic device side corresponding to user information that is sent from the client terminal for user authentication, and for a user to confirm in advance an output state of the image before image output.

1. An electronic device control system in which a client terminal and an electronic device capable of outputting an image in response to an instruction from the client terminal are connected to a network, wherein
the electronic device includes an authentication portion for performing user authentication according to an authentication request including user information that is sent together with image data from the client terminal; an output state determination portion for determining an output state of an image for the image data depending on the user information in a case where the user authentication is successfully performed; a preview image generation portion for generating a preview image corresponding to the output state for the image data; and a sending portion for sending to the client terminal a result of the user authentication to which the preview image is added only in a case where the user authentication is successfully performed, and
the client terminal includes a preview display portion for displaying an execution button for instructing the electronic device to execute image output together with the received preview image.

2. The electronic device control system as defined in claim 1, wherein
the client terminal sends function setting information that is used in the electronic device to the electronic device together with the image data.

3. The electronic device control system as defined in claim 2, wherein
the electronic device includes a restriction information storage portion for correlating and storing user information, restriction function information indicating a function whose usage is restricted among functions of the electronic device, and an alternative function information indicating a function that is used as an alternative of the restricted function.

4. The electronic device control system as defined in claim 3, wherein
the output state determination portion determines an output state of the image for the image data depending on the user information and the function setting information that are received from the client terminal with reference to the restriction information storage portion.

5. An electronic device that is connected to a client terminal via a network and capable of outputting an image in response to an instruction from the client terminal, comprising:
an authentication portion for performing user authentication according to an authentication request including user information that is sent together with image data from the client terminal;
an output state determination portion for determining an output state of an image for the image data depending on the user information in a case where the user authentication is successfully performed;
a preview image generation portion for generating a preview image corresponding to the output state for the image data; and
a sending portion for sending to the client terminal a result of the user authentication to which the preview image is added only in a case where the user authentication is successfully performed, wherein
image output for the image data is executed when an instruction to execute image output is received from the client terminal after the preview image is sent.

6. An electronic device control method in an electronic device control system in which a client terminal and an electronic device capable of outputting an image in response to an instruction from the client terminal are connected to a network, comprising the steps of:
sending an authentication request including user information together with image data to the electronic device by the client terminal;
performing user authentication according to the authentication request by the electronic device;
determining by the electronic device an output state of an image for the image data depending on the user information in a case where the user authentication is successfully performed;
generating a preview image corresponding to the output state for the image data by the electronic device;
sending to the client terminal by the electronic device a result of the user authentication to which the preview image is added only in a case where the user authentication is successfully performed; and
displaying by the client terminal an execution button for instructing the electronic device to execute image output together with the received preview image.
